(19) United States
(12) Patent Application Publication
(10) Pub. No.: US 2004/0217095 A1
(43) Pub. Date: Nov. 4, 2004

(54) Method for producing three-dimensional work pieces in a laser material machining unit or a stereolithography unit and unit for performing the method

(75) Inventor: Frank Herzog, Lichtenfels (DE)

Correspondence Address: LERNER AND GREENBERG, PA, P O BOX 2480, HOLLYWOOD, FL, 33022-2480, US

(73) Assignee: Concept Laser GmbH

(21) Appl. No.: 10/854,101

(22) Filed: May 25, 2004

Related U.S. Application Data
(63) Continuation of application No. PCT/DE02/04188, filed on Nov. 13, 2002.

(30) Foreign Application Priority Data
Nov. 26, 2001 (DE) 101 57 647.1

(51) Int. Cl. B23K 26/00

(52) U.S. Cl. 219/121.85

(57) ABSTRACT

In a method for producing three-dimensional work pieces in a laser material machining unit or a stereolithography unit either a layered sintered material or a pasty material is applied on a support from a supply device. The material is heated by laser irradiation area by area, such that the constituents of the sintered material or pasty material join in layers to form the work piece by at least partial melting, depending on the irradiated areas. The laser irradiation is carried out with a first energy density and/or a first focus diameter. During or after the work piece production process, areas of the work piece are either melted by laser with an increase in energy density or removed.

### CROSS-REFERENCE TO RELATED APPLICATION

This application is a continuation, under 35 U.S.C. § 120, of copending international application No. PCT/DE02/04188, filed Nov. 13, 2002, which designated the United States; this application also claims the priority, under 35 U.S.C. § 119, of German patent application No. 101 57 647.1, filed Nov. 26, 2001; the prior applications are herewith incorporated by reference in their entirety.

### BACKGROUND OF THE INVENTION

Field of the Invention

The invention relates to a method for producing three-dimensional work pieces in a laser material machining unit or a stereolithography unit and also to an apparatus for carrying out the method.

It is known to produce three-dimensional sintered work pieces in automatic laser sintering units, with sintering material, in particular powder-like sintering material, being applied layer by layer to a support from a supply device and heated by irradiating it area by area with laser radiation of a sintering laser in such a way that the constituents of the sintering material bond with one another in layers to form the work piece by partial melting, in a way dependent on the irradiated areas. For this purpose, laser radiation of a first energy density and/or a first focusing diameter is used. Similarly, methods of stereolithography are known in principle.

Sintering methods are used in particular in conjunction with powder-like sintering materials in order—depending on the starting material—to produce metallic work pieces or work pieces formed of plastic. Such work pieces must regularly undergo finishing work on account of the surface roughness and relative inaccuracy of their edges. This is attributable to the fact that the metal sintering process is limited with respect to the minimum particle size to be processed of the metal sintering powder. From particle sizes of k≦20 μm, coating with such powders becomes problematical, since they tend to develop pasty characteristics.

Furthermore, the sintering technology is generally limited by the minimum sintering track width that can be produced. On the one hand, it is not possible for geometries of any desired small size to be chosen, since the sintering process only works with specific focusing diameters. On the other hand, in the sintering process the powder particles adhere to the generated sintering track, which, on account of the heat influencing zone, regularly leads to coarser surface structures, and consequently to greater track widths than the focusing diameter that has been set. Furthermore, it has been found that all the surfaces that lie at right angles to the Z axis (vertical axis) have considerable roughness.

### SUMMARY OF THE INVENTION

It is accordingly an object of the invention to provide a method for producing three-dimensional work pieces in a laser material machining unit or a stereolithography unit and a unit for performing the method which overcome the above-mentioned disadvantages of the prior art devices and methods of this general type, such that the structure of the work pieces is improved both on the surface and internally, and in particular that extremely fine slits and undercuts can be produced in situ.

With the foregoing and other objects in view there is provided, in accordance with the invention, a method for producing three-dimensional work pieces in a laser material machining unit or a stereolithography unit. The method includes applying a material being either a sintering material or a pasty material, layer by layer to a support, from a supply device. The material is then heated into at least a partially melted state by irradiating the material area by area with laser radiation of a laser for bonding constituents of the material with one another in layers to form a work piece, in a way dependent on irradiated areas. The laser radiation is provided with a given energy density and/or a given focusing diameter. Areas of the work piece are removed or melted using the laser during or after the work piece formation process, by increasing the given energy density of the laser.

One feature of the invention is to melt or remove areas of the work piece by the laser during or after the work piece production process, by increasing the energy density of the laser. In this case, the depth of penetration of the laser beam may correspond approximately to the thickness of a material layer if the material layer is to be passed over only once and is to be compacted or smoothed. However, it is also possible to choose the depth of penetration to be somewhat less and to pass over the same material layer a number of times. In this way, the result is improved even further.

This makes it possible for work pieces to be produced with exact outer dimensions, for work pieces to have smooth surfaces from the outset not requiring special finishing work, and also for more compact components altogether to be produced and for extremely fine clearances to be created without removing the work piece and mounting it in another machining station and adjusting there. The method has the overall effect of considerably speeding up and reducing the cost of the production of sintered work pieces and of significantly increasing the quality of the work pieces.

For melting or removing the at least one material layer area by area, the sintering laser may be operated in a pulsed manner. However, there are also other possibilities for increasing the energy density, for example reducing the focusing diameter of the laser beam, it being possible for melting or removal for the focusing diameter of the laser beam to lie in the range between 10 micrometers and 400 micrometers.

If the sintering laser is disposed such that it can be made to move over the surfaces of the work piece, it is also possible to act on the surface of the work piece with the laser beam set at an angle, whereby undercuts with beveled surfaces are possible.

The method can be carried out either in such a way that each individual applied and sintered material layer is subsequently worked by removal or overmelting. Or else it is possible to perform complete melting of the powder particles right away during the first pass over the built-up layers of powder, whereby the layers become extremely dense, so that the sintering process becomes a powder re-melting process. Finally, it is also possible first to complete a number of material layers and then work them, i.e. carry out the cutting in or removal of clearances and overmelting. For reasons of time, it may be necessary for the work piece to contain a prepared metal plate, in particular a steel plate, to introduce clearances into the steel plate with the removal laser, for example to drill slits or holes, and to apply elevations to the surface of the steel plate with the aid of the sintering method. This results in a combined method, which is not possible with conventional automatic sintering units and sintering methods, because one and the same laser is used for the material removal, the finishing work on fully or partly produced, pre-worked parts and as a sintering laser for building up further elevations on the steel plate.

The removal or melting area by area may advantageously take place after a cooling phase of the last applied material layer. This avoids excessively high thermal stresses or overheated areas in the work piece causing distortions.

In principle it is possible to compact the component overall by melting the material layers. This presupposes that the material layers are initially fused to one another. Then, each material layer is melted once again and, as a result, a more intimate fusion of the particles is achieved. The result is a work piece with a higher density.

With the foregoing and other objects in view there is further provided, in accordance with the invention, an apparatus for producing three-dimensional work pieces. The apparatus contains a unit being either a laser material machining unit or a stereolithography unit. The unit contains a laser with elements for increasing an energy density. A supply device applies a material being either a sintering material or a pasty material, layer by layer, to a support. The material is at least partially melted by heating the material area by area with laser radiation from the laser for bonding constituents of the material with one another in layers to form a work piece, in a way dependent on irradiated areas. The laser radiation is provided with a given energy density and/or a given focusing diameter. Areas of the work piece are then removed or melted using the laser during or after the work piece formation process, by increasing the given energy density of the laser.

Ideally, the elements contain an optical focusing adjustment and/or a firing circuit configured for pulsed operation of the laser.

In accordance with an added feature of the invention, an electronically controllable compound slide rest drive is provided. The laser has a beam deflector and/or a beam diverter. The laser, the beam deflector, and/or the diverter is/are disposed on the electronically controllable compound slide rest drive above a machining surface of the unit.

In a further feature of the invention, a controller is provided for automatically re-focusing a laser beam of the laser to fall at an angle on a surface of the work piece.

Other features which are considered as characteristic for the invention are set forth in the appended claims.

Although the invention is illustrated and described herein as embodied in a method for producing three-dimensional work pieces in a laser material machining unit or a stereolithography unit and a unit for performing the method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIGS. 1A-1B are diagrammatic illustrations of method steps for sintering or fusing a component layer and a number of component layers;

FIGS. 2A-2D are diagrammatic illustrations of the method step of removing different amounts of a layer thickness;

FIGS. 3A-3D are diagrammatic illustrations of different possibilities for smoothing surface layers;

FIGS. 4A and 4B are diagrammatic illustrations illuminating method steps for removing and building up material layers;

FIGS. 5A and 5B are diagrammatic illustrations showing a method for producing work pieces with exact outer dimensions; and

FIG. 6 is a diagrammatic, illustration of an apparatus for producing three-dimensional work pieces with distance measurement and control.

### DESCRIPTION OF THE PREFERRED EMBODIMENTS

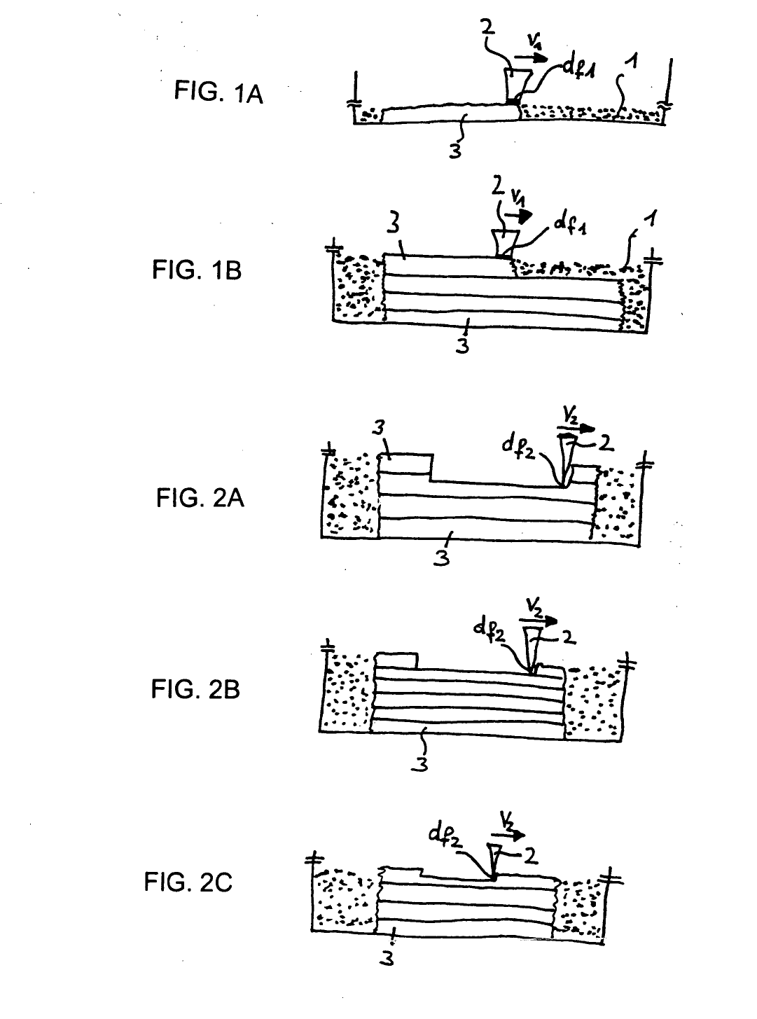

Referring now to the figures of the drawing in detail and first, particularly, to FIGS. 1A and 1B thereof, there is shown the basic representation of the method for producing three-dimensional work pieces in a laser material machining unit or in a stereolithography unit. The work piece is produced from a powder-like sintering material 1, or some other pasty material capable of sintering, being applied layer by layer to a support from a supply device. The material is heated by irradiating it area by area with laser radiation of a laser in such a way that the constituents of the sintering material 1 or of the pasty material bond with one another in layers to form the work piece by at least partial melting, in a way dependent on the irradiated areas, so that the material layers 3 are successively produced. The laser beam is provided with reference numeral 2. In this case, laser radiation with a first energy density and a first focusing diameter df₁, of a power P₁ (in the machining plane) or intensity I₁ (in the working focus) and an exposure rate v₁ is used. This then results in a specific energy per unit length E₁.

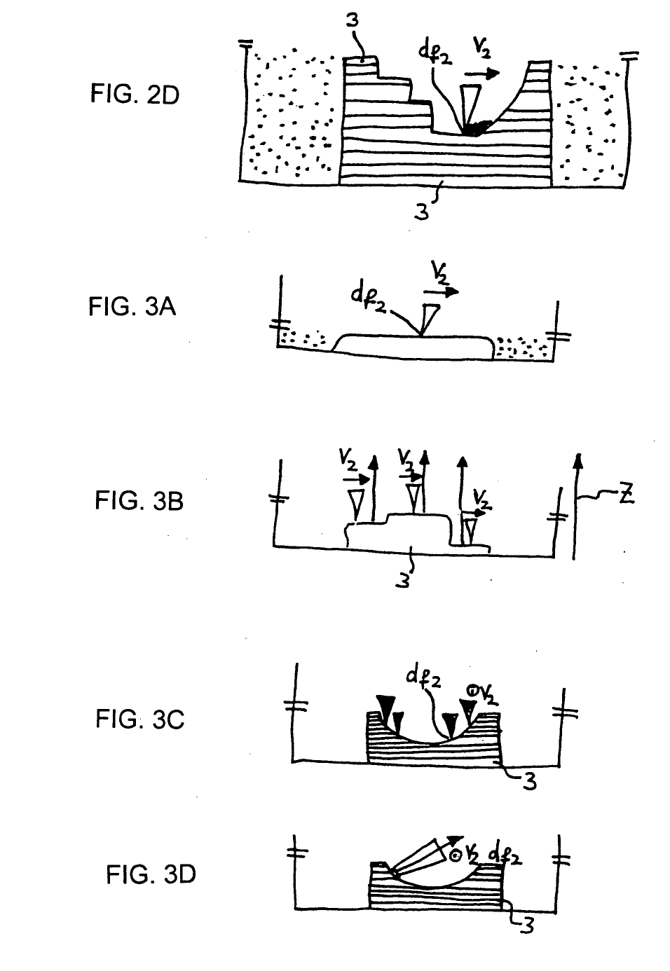

In the next method step according to FIGS. 2A-2D, with a number of alternatives being represented in FIGS. 2A-2D, areas of the work piece are removed by the laser during or after the work piece production process, by increasing the energy density of the laser. The laser beam 2 has in this case an exposure rate V₂, a laser power P₂ (in the machining plane) or an intensity I₂ (in the working focus) and consequently an energy per unit length E₂. The focus in the machining plane is denoted by df₂. For removing the at least one material layer 3, the focusing diameter df₂ of the laser beam 2 is in this case reduced. The focusing diameter of the laser beam 2 for melting and/or removal is between 10 and 400 μm.

The parameters with index 1 are consequently used for the melting of the sintering material, whereas the parameters with index 2 are used for the removal or smoothing of the material layers.

For melting and/or removing the at least one material layer 3 area by area, the laser may be operated in a pulsed manner.

In FIGS. 2A-2C, the removal takes place after the completion of a number of the material layers 3, with an area which is greater than one material layer 3 being removed according to FIG. 2A. In FIG. 2B, on the other hand, an area of the molten layer that corresponds to the amount or thickness of one material layer 3 is removed. In FIG. 2C, a layer that is smaller than the thickness of one material layer 3 is removed. FIG. 2D shows the removal of an area of the melted material layers 3 by a fraction of the thickness of the material layer 3 in each case, in a recurring sequence until a specific total layer thickness has been removed.

The removal or melting layer by layer expediently takes place after a cooling phase of the last applied material layer 3, so that thermal stresses are largely avoided.

In FIGS. 3A-3D, various possibilities for smoothing surface layers that have been produced in a way corresponding to FIGS. 1A and 1B are represented. It is also shown in this case that the respectively individual parameters, such as exposure rate v₂, laser power P₂ in the machining plane and intensity I₂ in the working focus, and also the focus df₂ in the machining plane, may deviate from the parameters that are set when melting the component layers. At the same time it is also possible for at least one parameter (for example the focus in the machining plane) in each case to remain the same, only the power, the intensity and/or the exposure rate changing, and vice versa. As a further parameter, an overlap Ü of the exposure vectors during smoothing (Ü₂) may also vary in comparison with melting (Ü₁).

The smoothing of the material layers 3 takes place with increased energy density of the laser beam 2. In FIG. 3A, the smoothing of the material layer 3 or of partial areas of this material layer 3 is represented. FIG. 3B shows the smoothing of partial areas of the work piece for which the surface vectors lie parallel to the vertical axis Z. In FIG. 3C, the smoothing of component surfaces by passing once again over all the component contours after removing loose powder, with the laser beam constantly vertical, is represented. FIG. 3D shows the smoothing of component surfaces by the laser beam 2 aligned perpendicularly in relation to the machining point.

In FIGS. 5A and 5B, the smoothing of component layers by removal of superficial layers is represented. FIG. 5A shows the laser beam 2 placed on an edge of the component. FIG. 5B shows the result after removal of the component contour, with a smaller average surface roughness R_{z} than before the smoothing process. The smoothing in turn takes place after the melting of at least one or more material layers according to FIGS. 1A and 1B. After that, the component contour is removed after every layer or every nth layer by following the contour, so that well-defined transitions, smooth outer surfaces and dimensionally stable layers are created. At the same time, a speed-dependent power adaptation is intended to provide a constant energy per unit length E₂ and guarantee uniformity of the contour following. If the laser output is disposed on a compound slide rest, it is possible by making the compound slide rest move over the work piece to achieve the effect that the laser beam impinges at right angles on the work piece surface, whereby the removal accuracy is further improved.

The material layers 3 may be produced with oversize in the edge region of all the component surfaces with the surface lying substantially at right angles to the vertical axis, and the oversize subsequently removed by using laser radiation of increased energy density, in order to achieve smooth surfaces and contours. Similarly, after applying the material layers 3, it may be provided that they are compacted once again by melting.

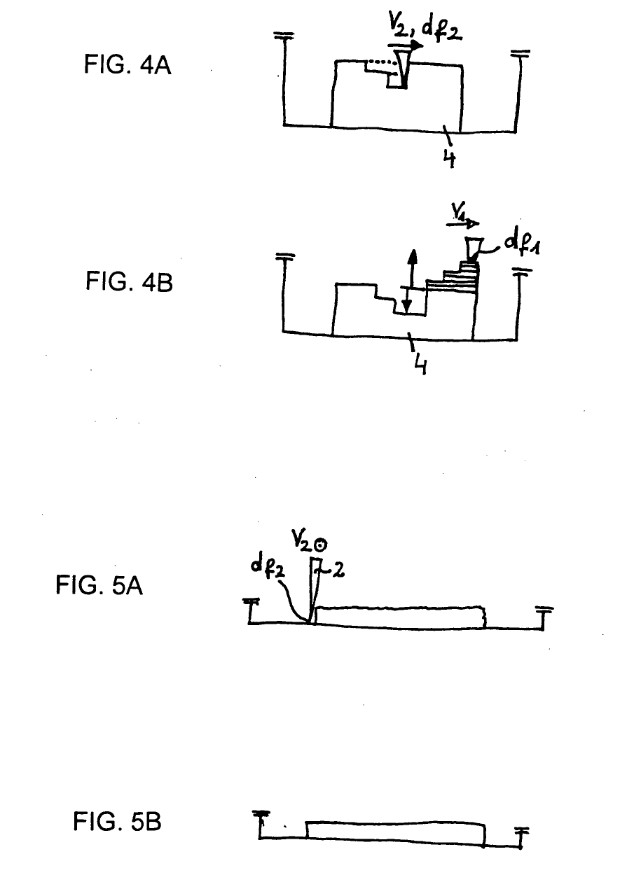

In FIGS. 4A and 4B, a hybrid method is represented, removal first being performed on a prefabricated substrate plate in a way according to FIG. 4A and then raised regions of the component being generated by re-melting of metal powders in a way according to FIG. 4B. In this case, a distance measurement is to take place between every removal layer or after a specific number of removal layers, and the reaching of the desired removal depth is to be ensured in a software-based technical control process.

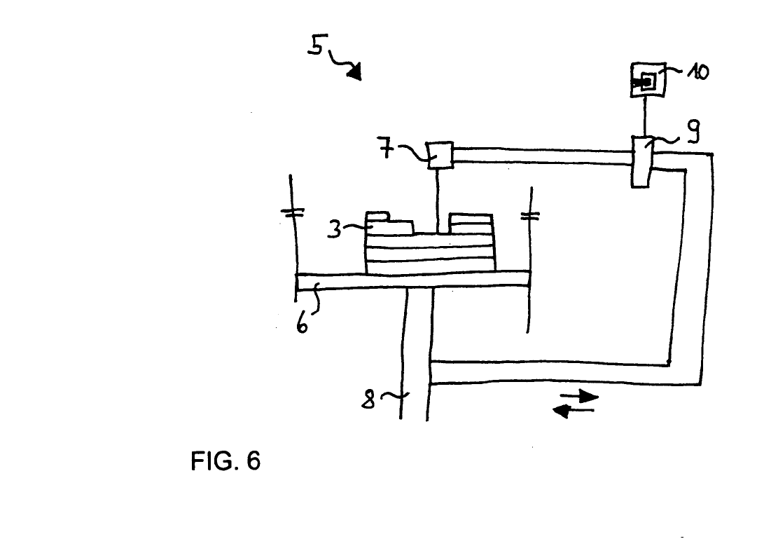

The apparatus for carrying out the aforementioned methods is provided with a laser with elements for increasing the energy density. However, this apparatus is not represented in any more detail in FIG. 6 of the drawing. The elements contain an optical focus adjustment and may contain a firing circuit for pulsed operation of the sintering laser. In the apparatus drawn in principle in FIG. 6, the distance measurement and control is represented, allowing a desired removal depth or build-up height to be ensured. Provided for this purpose is a distance meter 7, which measures the distance for example by infrared light or light sources in some other spectral range. An adjusting axis 8 permits an adjustment of the building platform 6 in all directions and the rotation of the building platform 6. The desired data can be entered in a computer 9. The computer 9 also compares the measured component dimensions with the data entered and sets the adjustment axis 8 under closed-loop or open-loop control. A monitor 10 enables the operator continuously to check the data in a simple way.

The laser or the beam deflection or diversion itself is disposed on an electronically controllable compound slide rest drive, which however is not included in the apparatus 5 for reasons of overall clarity, above the building platform 6. The control configuration may also serve for automatically re-focusing the laser beam 2 falling at an angle on a surface of the work piece.

I claim:

1. A method for producing three-dimensional work pieces in a laser material machining unit or a stereolithography unit, which comprises the steps of:
applying a material selected from the group consisting of sintering materials and pasty materials, layer by layer to a support, from a supply device;
heating the material into at least a partially melted state by irradiating the material area by area with laser radiation of a laser for bonding constituents of the material with one another in layers to form a work piece, in a way dependent on irradiated areas, the laser radiation being provided with at least one of a given energy density and a given focusing diameter; and
performing one of removing and melting areas of the work piece using the laser during or after the work piece formation process, by increasing the given energy density of the laser.

2. The method according to claim 1, which further comprises operating the laser in a pulsed manner for removing and/or melting the areas of the material area by area.

3. The method according to claim 1, which further comprises reducing the given focusing diameter of a beam of the laser during the removing or melting step.

4. The method according to claim 1, wherein during the melting step, increasing the given focusing diameter while at a same time increasing the given energy density.

5. The method according to claim 3, which further comprises setting the given focusing diameter of the beam in a range of between 10 micrometers and 400 micrometers during the removing or melting step.

6. The method according to claim 1, which further comprises moving the laser or an associated beam deflecting unit over surfaces of the work piece.

7. The method according to claim 1, which further comprises forming the work piece to be selected from the group consisting of metal-sintered work pieces and metal-fused work pieces.

8. The method according to claim 1, which further comprises performing the removing step area by area after a number of the layers have been applied and the removing step penetrates through a given number of the layers.

9. The method according to claim 1, which further comprises performing a cooling phase after a last layer of the material has been formed before performing the removing or melting step.

10. The method according to claim 1, which further comprises after producing at least one of the layers of the material, following a work piece contour with a beam of the laser having an increased energy density compared to the given energy density, resulting in an edge of the work piece being at least one of removed and smoothed.

11. The method according to claim 1, which further comprises compacting the work piece by melting the material of the layers after the layers have been applied.

12. The method according to claim 1, which further comprises:
producing the layers of the material with oversizes in an edge region of all work piece surfaces with the surfaces lying substantially at right angles to a vertical axis; and
removing the oversizes with the laser radiation having an increased energy density compared to the given energy density, for achieving smooth surfaces, smooth contours, and a high-precision work piece.

13. An apparatus for producing three-dimensional work pieces, comprising:
a unit selected from the group consisting of a laser material machining unit and a stereolithography unit, said unit containing a laser with elements for increasing an energy density; and
a supply device applying a material selected from the group of sintering materials and pasty materials, layer by layer, to a support, the material being at least partially melted by heating the material area by area with laser radiation from said laser for bonding constituents of the material with one another in layers to form a work piece, in a way dependent on irradiated areas, the laser radiation provided with at least one of a given energy density and a given focusing diameter, areas of the work piece being removed or melted using the laser during or after the work piece formation process, by increasing said given energy density of said laser.

14. The apparatus according to claim 13, wherein said elements contain an optical focusing adjustment.

15. The apparatus according to claim 13, wherein said elements contain a firing circuit configured for pulsed operation of said laser.

16. The apparatus according to claim 13,
further comprising an electronically controllable compound slide rest drive; and
wherein said laser has at least one of a beam deflector and a beam diverter, one of said laser, said beam deflector, and said diverter is disposed on said electronically controllable compound slide rest drive above a machining surface of said unit.

17. The apparatus according to claim 13, further comprising a controller for automatically re-focusing a laser beam of said laser to fall at an angle on a surface of the work piece.
